(19) United States
(12) Patent Application Publication
(10) Pub. No.: US 2026/0268275 A1
(43) Pub. Date: Sep. 10, 2026

(54) AGRICULTURAL PRODUCT TRACKING METHOD AND SYSTEM

(71) Applicant: 10141120 MANITOBA LIMITED, Steinbach (CA)

(72) Inventors: Ellery BURTON, Steinbach (CA); Colin ROSENGREN, Steinbach (CA)

(21) Appl. No.: 19/161,093

(22) PCT Filed: Jun. 25, 2024
(86) PCT No.: PCT/IB2024/056172

§ 371 Date: Aug. 29, 2025

Related U.S. Application Data
(60) Provisional application No. 63/523,204, filed on Jun. 26, 2023.

(51) Int. Cl. G06Q 10/087; G06Q 50/02

(52) U.S. Cl. CPC G06Q 10/08772; G06Q 50/02

(57) ABSTRACT

This invention relates to a method and system of autonomously tracking a batch of agricultural product through the various stages of harvest, transportation and storage. Said method and system comprise a plurality of sensors and RFID tags positioned on the agricultural product conveying devices, transport containers, and storage bins such that information, such as date, time, equipment involved and location, is recorded at each transfer of a batch of agricultural product. The data collected on transfer is uploaded to a virtual or physical database in association with a batch identifier, and the database can be queried to access information regarding the quality, quantity and attributes of the batch of agricultural product.

### FIELD OF THE INVENTION

The invention relates generally to agricultural product tracking. In particular, the invention relates to a method and system for autonomously tracking batches of agricultural product, such as grain growing in a field location, through the different stages of harvest, transportation, and storage.

### BACKGROUND

It has become increasingly difficult for farmers to track their own farm inventory. As farms have grown in size and labor force, there can be many employees moving grain on a farm, making inventory management a significant challenge. These logistical challenges are factors that affect a farmer's ability to diversify into more crops, and can affect both agronomic and business decisions. Furthermore, poor inventory management can negatively affect a producer's marketing ability and effectiveness. Without adequate systems in place, farmers will struggle to know the quantity and quality of the products on hand. This creates issues and losses in the system when quality or quantity is not what is expected by the buyer, or there are missed marketing opportunities with over or under estimates of volumes on hand. Furthermore, manual sampling and traceability methods currently being used are prone to error and result in grain products of unknown quality or exact source (field) location. These frustrations can also affect a farmer's attitude toward growing special market crops, which may negatively affect their business.

Current grain tracking systems require the manual input of data at various points along the transportation and storage process, and they lack sufficient and accurate tracking from the farmer's field to the point of sale. Reliance on manual data input has several disadvantages such as inaccurate entries, missed entries and increased stress on a farm's workforce. There is a need in the art for a comprehensive and automated system for the tracking of grain from harvest to storage and distribution.

### SUMMARY OF THE INVENTION

The present invention relates to a method and system for tracking an agricultural product from harvest, through transport, storage and distribution.

According to the present invention, there is provided a method of autonomously tracking a batch of agricultural product, by first creating a batch of an agricultural product at a point of harvest in a virtual space that mirrors and is associated with a physical batch of harvested agricultural product. The movement of said agricultural product is then tracked by a plurality of sensors, which detect the presence of radio-frequency identification (RFID) tags respectively associated with different stages of agricultural product harvest, transportation, and storage. These sensors are configured to identify the batch of agricultural product and to send sensor data in association with a batch identifier to a virtual or physical database. The sensor data is at least one of the time of agricultural product movement, date of agricultural product movement, equipment involved and location. The stored data can then be queried for a particular batch of agricultural product, and in response to said query, sensor data associated with a batch identifier can be output for display.

In a further embodiment, there is provided the above method wherein additional data is measured by additional sensors and this data is associated with the batch of agricultural product. This additional data may be collected before agricultural product movement, during agricultural product movement, after agricultural product movement, or any combination thereof.

In a further embodiment, there is provided the above method wherein the additional data for a batch of agricultural product may comprise one or more of: volume, mass, harvest location coordinates, moisture content, protein content, crop variety, crop type, nutritional properties, seed application data, chemical application data, fertilizer application data, soil conditions, soil type, agronomy data, seed type, certifications, weather data throughout crop lifecycle, crop-specific data, carbon sequestration or emissions, or any combination thereof.

In a further embodiment, there is provided the above method further comprising accessing the database that stores the agricultural product data and determining one or more properties associated with the batch of agricultural product in response to the query. The queried data is then output for display to the user.

In a further embodiment, there is provided the above method wherein the sensors and RFID tags may be placed on one or more of a harvester, tank, cart, truck, truck container, auger, leg, conveying device, storage bin, grain bag, temporary storage pile, rail car, bulk transport trailer, and feed wagon.

In another embodiment of the present invention, there is provided a system for autonomously tracking a batch of agricultural product. This system may comprise a processor and a non-transitory computer-readable memory having computer-executable instructions stored thereon, which when executed by the processor configure the system to perform the method outlined above.

In a further embodiment, there is provided the above system, which further comprises a plurality of sensors.

In a further embodiment, there is provided the above system which may further comprise a system and components for serialized sampling of a batch of agricultural product, wherein the samples are collected from a location along the different stages of agricultural product harvest, transportation, and storage. In this system, the serialized samples are collected, segmented into tamper-proof containers, and stored separately from the storage bin for that batch of agricultural product. These samples are then virtually associated with the batch of agricultural product via a unique identification number, label, RFID chip, bar code, QR code, or serial number. The agricultural product samples, which are sealed in tamper-proof containers are representative samples of the batch from which they were taken.

In a further embodiment, there is provided the above system wherein the tamper-proof containers may be bags, jars, or pails.

In a further embodiment, there is provided the above system wherein the tamper-proof containers may be affixed with a label with the batch data, sensor data, and/or some or all of the additional data collected for that batch of agricultural product on the label.

In another embodiment of the present invention, there is provided a method of autonomously tracking a batch of agricultural product, by first creating a batch of an agricultural product at a point of harvest in a virtual space that mirrors and is associated with a physical batch of harvested agricultural product. The movement of said agricultural product is then tracked by a plurality of sensors, which are configured to detect the location and working state of harvesting, transportation and storage equipment handling the agricultural product and to send sensor data to a processor. The sensor data is at least one of the time of agricultural product movement, date of agricultural product movement, equipment involved, operational state of the equipment involved and location. The processor is configured to determine a state of the batch of agricultural product based on the sensor data and to associate a batch identifier with the sensor data. The processor is further configured to send the sensor data in association with the batch identifier to a physical or virtual database for storage. The stored data can then be queried for a particular batch of agricultural product, and in response to said query, sensor data associated with a batch identifier can be output for display.

In a further embodiment, there is provided the above method wherein the plurality of sensors are further configured to detect at least one of an orientation, a speed, an acceleration and a relative position with respect to other equipment of the harvesting, transportation and storage equipment.

In a further embodiment, there is provided the above method wherein the plurality of sensors are further configured to detect at least one of a change in weight and a direction of change in weight and sub-equipment working state of the harvesting, transportation and storage equipment.

### BRIEF DESCRIPTION OF THE DRAWINGS

These and other features of the invention will become more apparent from the following description in which reference is made to the appended drawings wherein: FIG. 1 shows a diagram of an example of the grain tracking system, which comprises (a) grain being harvested by a harvester (10), from which grain gets passed sequentially by conveying devices (40) to (b) a grain cart (50), (c) a grain truck (60), (d) a grain leg (70), and (e) into a storage bin (80). Grain can then be moved to (f) a grain truck (60) for transport to a purchaser. Readers (20) are placed on the conveying devices such that they are in proximity of tags (30) placed on the entities described in (b) to (f) when grain is being transferred.

FIG. 2 shows a diagram of an example of the grain tracking system, comprising reader/tag systems (90) and data upload points to a virtual repository (100) indicated.

FIG. 3 shows a front plan cross-sectional view of an example grain volumetric flow measuring device (91).

FIG. 4 shows a diagram of an example of the grain sampling system, wherein a gaited tap (110) is present in the grain conveying device (40) that leads to the grain storage bin (80), and this tap siphons off portions of grain into an automatic sampling machine (120), which then packages grain into tamper-proof containers (130), which can then be stored in a separate storage unit (140). Each of the tamper-proof containers is given a unique serial number that is correlated to the batch of grain from which it came, such that the samples become representations of the batch in terms of grain attributes (such as quality, colour, protein content and other value or grade indications).

### DETAILED DESCRIPTION

Described herein are methods and systems for autonomously tracking samples of an agricultural product, such as grain or other agricultural products.

According to an aspect of the invention there is provided a method for autonomously tracking a batch of an agricultural product. The method includes:
creating a batch of agricultural product at a point of harvest in a virtual space that mirrors and is associated with a physical batch of harvested agricultural product,
detecting, by a plurality of sensors, the presence of radio-frequency identification (RFID) tags respectively associated with different stages of agricultural product harvest, transportation, and storage, wherein each of the plurality of sensors are configured to identify the batch of grain and to send sensor data in association with a batch identifier, wherein the sensor data are at least one of time of agricultural product movement, date of agricultural product movement, equipment involved and location,
sending to a virtual or physical database the sensor data collected by the plurality of sensors in association with the batch identifier,
storing in the virtual or physical database the sensor data received from the plurality of sensors in association with the batch identifier,
receiving a query for the batch of agricultural product,
in response to the query, accessing the physical or virtual database to determine the associated sensor data for said batch of agricultural product, and
outputting the sensor data and associated batch identifier for display.

In an embodiment, the method is described as a method for automatically tracking grain as the agricultural product. However, it is contemplated that this method could be used to track other agricultural products as well, including, but not limited to, fruit, vegetables, seed, or meat.

In the described embodiment, a batch of agricultural product is defined in this instance as a volume or mass of agricultural product that could be as small as a single item (for example, a single grain, seed, or piece of fruit) or as large as would be known by someone of skill in the art.

According to another aspect of the invention there is provided a method for autonomously tracking a batch of an agricultural product. The method includes:
creating a batch of agricultural product at a point of harvest in a virtual space that mirrors and is associated with a physical batch of harvested agricultural product,
detecting, by a plurality of sensors, the location and working state of harvesting, transportation and storage equipment handling the agricultural product wherein each of the plurality of sensors are configured to collect and send sensor data, wherein the sensor data includes at least one of time of agricultural product movement, date of agricultural product movement, equipment involved, operational state of the equipment involved and location,
sending to a processor the sensor data collected by the plurality of sensors,
determining, by the processor, a state of the batch of agricultural product based on the sensor data and associating a batch identifier with the sensor data,
sending to a physical or virtual database the sensor data in association with the batch identifier,
storing in the virtual or physical database the sensor data in association with the batch identifier,
receiving a query for the batch of agricultural product,
in response to the query, accessing the physical or virtual database to determine the associated sensor data for said batch of agricultural product, and
   outputting the sensor data and associated batch identifier for display.

The point of harvest for an agricultural product is generally a farmer's field, but could be anywhere where the agricultural product is grown. The point of harvest may be indicated by longitude/latitude coordinates or Global Positioning System (GPS) coordinates to identify precisely the region where the batch was harvested from.

In the present embodiment, creating a batch of an agricultural product in a virtual space that mirrors and is associated with a physical batch of harvested agricultural product refers to creating a record of a user-defined volume or mass of agricultural product in a repository or database, with an associated unique identifier, that matches that mass or volume of agricultural product being harvested, transported or stored. Creating the batch in the virtual space that mirrors and is associated with a physical batch of harvested agricultural product is closely related to creating a digital twin of the physical batch of harvested agricultural product; however, digital twins include two-or three-dimensional Computer Assisted Design (CAD) models of the physical objects they mirror in addition to data pertaining to the physical objects, and the batch in the virtual space of the present embodiment needs not include a CAD model, as including CAD models can result in large data handling and storage requirements that add little value when the models are of a material that does not have a fixed three-dimensional shape, such as, for example, a batch of grain. Once the batch of agricultural product is created, a plurality of sensors and tags positioned at various points along the harvesting, transportation, and storage equipment can track the movement of the agricultural product. In an embodiment, it is envisioned that these sensors would be radio-frequency identification (RFID) readers that may be placed at the intake and/or outlet of every agricultural product moving device on a farm. Taking grain as an example agricultural product, these conveying devices could include a combine auger, grain cart auger, yard conveyor, bucket elevator, grain leg, or yard auger, without being limiting. RFID tags may be placed at the top and/or bottom of all transport and storage devices such as trailers, trucks, carts, and storage bins, without being limiting. When an RFID reader (sensor) comes in proximity to an RFID tag, information is passed to the respective sensor and associated with a batch of agricultural product. The information gathered from the RFID tag could include, but is not limited to, the location of the agricultural product, the date, and the time of tag reading and an identifier of the tag itself. This sensor data is gathered at each movement of a batch of agricultural product along the transportation and storage system, with the sensor data continually being associated with a given batch of agricultural product under its unique identifier. There may also be unique identifiers associated with each piece of equipment that handled the agricultural product.

It is envisioned that the RFID tags in this system may be passive RFID tags or active RFID tags. Alternatively, other reader/tag systems may be used, such as barcodes and barcode scanners, near field communication systems, QR codes and readers, wired ID chips and readers, wi-fi systems, Bluetooth systems, and Zigbee and Z-wave systems, or a combination of these systems may be used. Alternatively, LoRa, GPS, proximity or other locating device technologies could be used, whereby these technologies are triggered by equipment loading or unloading, with proximity technology noting two pieces of equipment in close proximity during the loading or unloading process as a method to determine when the batch of agricultural product has transferred from one piece of equipment to another. Alternatively or in addition to the sensors and tags, a batch of agricultural product can be further tracked by the processor by determining the state of the batch of agricultural product along the harvesting, transportation, and storage system by additionally determining the operational state of the equipment involved in the harvesting, transportation, and storage of a specific batch of agricultural product. For example, by determining metrics such as the position, orientation, speed or acceleration of the equipment, the processor may determine that the specific batch of agricultural product is being stored or held at a place or being transported to a subsequent location. Additionally, by determining the relative position of the equipment currently handling the specific batch of agricultural product with respect to other equipment, the processor may determine whether the specific batch of agricultural product is in process to being delivered to a further specific piece of equipment. Additionally, by determining a change in weight and a direction of a change in weight (for example, weight increasing) of the equipment handling the specific batch of agricultural product, the processor may determine whether the specific batch of agricultural product is being delivered to, or retrieved from the equipment. Furthermore, by determining sub-equipment working state of the harvesting, transportation and storage equipment, for example, an auger in operation state, a mixer in operation state, etc., the processor may further determine the status of the specific batch of agricultural product within the harvesting, transportation and storage system.

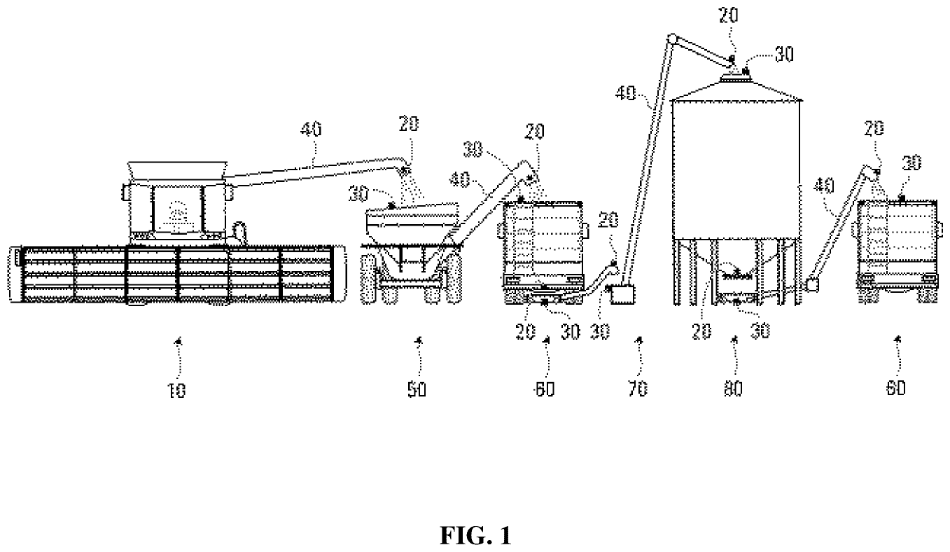

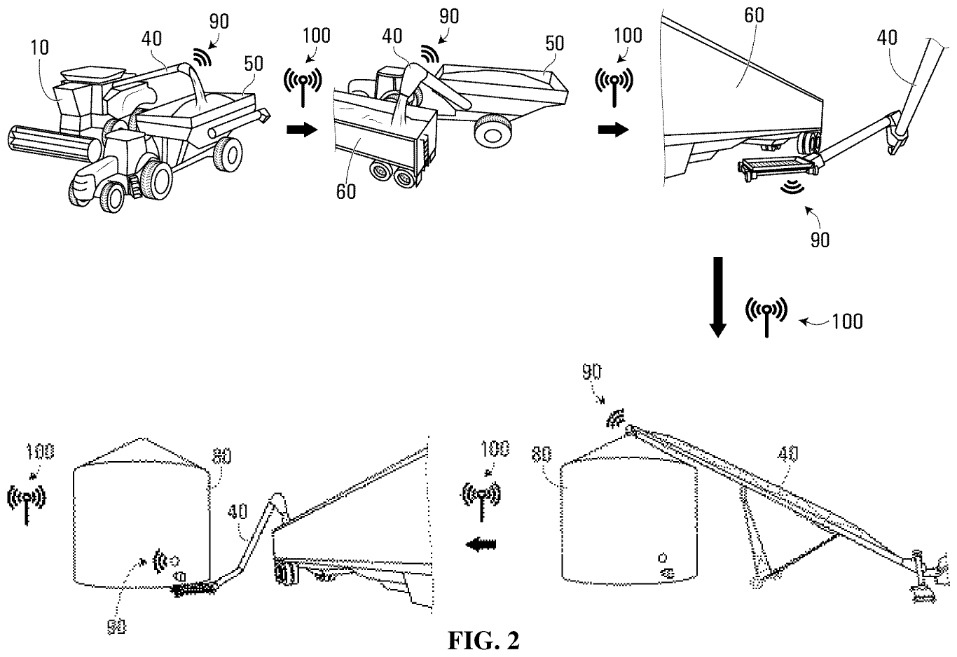

The plurality of sensors positioned at various points along the harvest, transportation and storage equipment can include additional sensors configured to measure additional information regarding the agricultural product, for example, to measure one or more of: volume, mass, harvest location coordinates, moisture content, protein content, crop variety, crop type, nutritional properties, seed application data, chemical application data, fertilizer application data, soil conditions, soil type, agronomy data, seed type, certifications, weather data throughout crop lifecycle, crop-specific data, carbon sequestration or emissions, or any combination thereof. The additional sensors can include volume sensors and mass sensors as further discussed below with reference to FIG. 2. The additional sensors can also include location coordinate sensors such as GPS sensors that can be included or additional to the harvesting, transportation and storage equipment. As an alternative to using GPS sensors, a different position determination system can be employed, for example, a beacon-based system comprising beacons or transmitters installed within the field and a series of receivers installed in the harvesting, transportation and storage equipment configured to receive signals from the beacons and to triangulate the position of the receiver within the field based on the received signals. The additional sensors can also include weather sensors that can include one or more local weather sensors such as temperature, humidity and pressure sensors and remote weather sensors that continuously record and store weather data in a regional weather database that can be accessed by the processor, for example through wireless communication at the different stages of the harvesting transportation and storage of the agricultural product. The additional sensors can also include soil sensors that can be arranged at different locations along a crop field and be wirelessly communicatively connected to the processor or that can be arranged on the harvesting equipment to measure soil conditions at harvest time. The additional sensors can also include agricultural product properties sensors such as agricultural product moisture sensors, grain quality sensors such as optical sensors configured to measure grain size, color, uniformity, etc. and Near Infra Red (NIR) spectroscopy sensors to measure protein, starch, and oil content in the grain. The additional sensors can also include humidity sensors to measure the humidity in the air surrounding the grain and gas sensors such as CO2 sensors to detect grain respiration and potential grain spoilage and Oxygen sensors to monitor storage conditions and detect potential spoilage, etc. The additional sensors can be configured to perform measurements and provide the measurements to the processor automatically, for example, at regular time intervals, when a level exceeds a predetermined threshold, at specific events in the harvesting, transportation and storage stages of the agricultural product, or in response to a command from the processor. Alternatively, some of the data measured by the additional sensors may be manually provided to the processor by the user.

The sensor data collected for a batch of agricultural product is to be stored in a physical or virtual database. A physical database is defined as a physical data storage system, such as a hard drive, whereas a virtual database refers to non-physical storage, such as blockchain or cloud repositories, without being limiting. If a physical database is used, it is envisioned that this database could be on site at the farm or elsewhere, without being limiting. These databases may also contain additional data which may be collected by separate sensors such as the additional sensors, and this additional data is associated with a batch of agricultural product. The additional data could include volume, mass, harvest location coordinates, moisture content, protein content, grain variety, crop type, nutritional properties, seed application data, chemical application data, fertilizer application data, soil conditions, soil type, agronomic data, seed type, certifications, weather data throughout crop lifecycle, crop-specific data, carbon sequestration or emissions, or any combination thereof. Harvest location coordinates may refer to either field grid coordinates from the harvest location, latitude and longitude coordinates, and/or GPS coordinates for the location of the field. Nutritional properties of an agricultural product may include water content, protein content, oil content, carbohydrate content, minerals present, vitamins present, fiber levels, antioxidant levels, phytic acid content, and tannin levels, without being limiting. Seed application data are data regarding how seeds were planted in a field including, but not limited to, seed distribution and the quantity of seed distributed (for example in lbs/acre). Chemical application data refers to data on the chemicals, such as insecticides, that were used on the agricultural product. Fertilizer application data is data on the type and/or amount of fertilizer used in the soil where the crop was grown. Soil conditions may include such measurements as aggregate stability, available water capacity, bulk density, infiltration, slaking, soil crusts, soil structure and macropores, particulate organic matter, mineralized nitrogen, soil enzymes, soil respiration, total organic carbon, soil microbiome, earthworms, reactive carbon, soil electrical conductivity, soil nitrate, soil pH, potassium levels, phosphorus levels, and cation exchange capacity, without being limiting. Agronomic data may include soil analysis, nutrient analysis, plant populations, yield data, or any other data regarding the activities or conditions on farm fields. Certifications may refer to Gluten-free Certification, Environmental Certifications and Practices, Organic, Non-Genetically Modified (GMO), without being limiting. Crop-specific data may refer to the species or color, without being limiting. Some of this data, such as soil conditions and grain nutritional properties, may be collected by analytic services or in-house analytic devices. It is envisioned that this data would be uploaded to the database in association with the identifier of the agricultural product in question.

In one possible embodiment, the database that holds the information associated with batches of agricultural product can be queried by a user to determine the location and associated attributes of a batch or batches of agricultural product that are of interest. The queries and output of information may be done through an app or through computer software, either existing or developed for this purpose. The data is preferably displayed on an electronic device, such as a computer, tablet, or phone, without being limiting, but physical printouts of this information may also be possible. With respect to the queries themselves, it is envisioned that the database could be searched using identifiers or properties associated with the agricultural product being tracked, without being limiting.

Identifiers which may be used to uniquely identify batches of agricultural product, sensors/tags, or pieces of machinery that carry or convey such agricultural product may be any desired combination of letters, symbols, and/or numbers that would uniquely identify said entity. With regard to location data, it is envisioned that this could include longitude/latitude coordinates, GPS coordinates, street address, city, state/province/territory, and/or country, without being limiting. When the location pertains to the position of a batch of grain at the point of harvesting, the position may include grid or GPS coordinates from the field from which it was taken.

The different stages of harvest, transportation, and storage mentioned above could include, without being limiting, harvesting machines, such as combine harvesters, conveyer devices, elevators, bins, trucks, carts, hoppers, augers, storage bins, silos, train cars and ships as would be known by someone of skill in the art.

Another embodiment of the present invention, relates to a system for autonomously tracking a batch of agricultural product, comprising a processor and a non-transitory computer-readable memory having computer-executable instructions stored thereon. When these instructions are executed by the processor it configures the system to perform the method described above for tracking a batch of agricultural product. The processor may be any device capable of executing the machine-readable instructions stored in the non-transitory computer-readable memory, such as an integrated circuit, a microchip, a computer, or any other computing device.

The non-transitory computer-readable memory of the system is communicatively coupled to the processor, and may comprise RAM, ROM, flash memories, hard drives, or any non-transitory memory device capable of storing a machine-readable instructions such that the machine-readable instructions can be accessed and executed by the processor. The machine-readable instruction set may comprise logic or algorithm(s) written in any programming language of any generation (e.g., 1GL, 2GL, 3GL, 4GL, or 5GL) such as, for example, machine language that may be directly executed by the processor and stored in the non-transitory computer-readable memory. Alternatively, the machine-readable instruction set may be written in a hardware description language (HDL), such as logic implemented via either a field-programmable gate array (FPGA) configuration or an application-specific integrated circuit (ASIC), or their equivalents. While a single non-transitory computer-readable memory module is envisioned, other embodiments may include more than one memory module.

In an embodiment, it is envisioned that the agricultural product being harvested, transported and stored is grain. In such an embodiment, a plurality of tags and sensors are positioned along a grain harvesting, transportation and storage system. As a crop is being harvested, the harvesting device, such as a combine harvester, or separate hardware device, may automatically record data such as grid coordinates, yield map, moisture content, crop type, variety, fuel usage, speed, work rate, losses, and other field data, as well as the date and time of collection, as the grain enters a grain tank, or similar vessel and provide the recorded data to the processor by wired or wireless communication, for example, via a Controller Area Network Bus (CANBUS) connection. Alternatively, at least a portion of the data may be provided by a user to the processor through a user interface device such as, for example, a tablet device communicatively connected to the processor. Additionally, at least a portion of the data, including essential batch data such as location, time, equipment handling the batch, etc. may be automatically recorded by the processor. Once the grain tank is full or a user-defined volume of grain has been collected, that batch of grain may be manually or automatically assigned a unique Batch identifier, which is stored on a database with its associated data.

Alternatively, it is envisioned that a Batch identifier would be assigned, manually or automatically, when the harvester begins to harvest the grain. In this instance, the next batch of grain would be created when the offloading of the previous batch is complete. In this way, the batch is being built in real-time with data, such as grid coordinates, yield map, moisture content, crop type, variety, fuel usage, speed, work rate, losses, and other field data being associated with the batch being built, and, for example, a final volume for the batch can be recorded and associated with the batch when the offloading of the batch is complete. The batch identifier enables additional information to be associated to the batch at a subsequent step, for example, when the batch is handed off to other pieces of equipment and/or storage.

The grain tank that houses that particular batch of grain is then emptied via a grain auger, or similar device, into a grain cart, or similar vessel. The outlet of the grain conveying device from the grain tank to the grain cart has a sensor or reader, which, when it comes into proximity of a tag placed on the grain cart, automatically records at the least the date, time, equipment involved and location and uploads this information to the database in association with the Batch or Batches being transferred into the cart. The cart is given a unique Processing Group identifier as well. The Processing Group identifier is stored on the database along with the data for the individual Batch or Batches in that group of grain. At a user-defined time, the grain cart is then emptied into one or more transport containers. The outlet of the conveying device that moves the grain from the grain cart to the transport container has a sensor or reader. When the sensor or reader comes into proximity of a tag placed on the transport container, the sensor or reader automatically records at least the date, time, and location of transfer and automatically uploads the data to the database in association with the Batch and Processing Group identifiers for the grain being transferred. Once the transfer is complete, or stopped at a user-defined time, this Transport Group is given a unique identifier, which is stored with all of the data associated with Processing Group(s) and Batch(es) contained within the transport container. The grain contained within the transport container is then moved to a storage site, where it is offloaded into a grain storage bin, or similar vessel. The offloading process may comprise moving the grain into the storage container via a leg, auger, or other conveying device, as would be known by someone of skill in the art. The inlet of the conveying device has a sensor or reader that records at least the date, time, and location when in proximity of a tag on the transport container. This data is automatically uploaded to the database in association with the Transport Group, Processing Group(s), and Batch(es) of the grain being transferred. Further, the outlet of the grain conveying device may have a sensor or reader that records at least the date, time, equipment involved and location when it comes into proximity of a tag on a storage bin, into which the grain is being emptied. Each storage bin would be given its own unique Storage Group identifier that would be stored in the database, along with the Transport Group, Processing Group and Batch data associated with the grain within the storage container. A given storage bin may contain one or more Transport Groups.

FIG. 1 shows an example of a grain tracking system. In this embodiment, grain is harvested by a harvester (10) which then unloads said grain into a grain cart (50) at a desired time via a conveying device (40). A reader (20) is positioned on the conveying device such that when it comes in proximity of a tag (30) on the grain cart (50), the reader automatically records data regarding the transfer. The grain cart (50) then empties into a grain truck (60) via a conveying device (40), and again a reader (20) situated on the conveying device (40) automatically records data when it comes into proximity of a tag (30) on the grain truck (60). The grain truck (60) then travels to a grain storage site, where it is offloaded into a grain storage bin (80) via a grain leg (70). In this embodiment, a reader (20) and tag (30) system automatically record data regarding the transfer when the grain truck (60) offloads the grain and when the grain enters the grain storage bin (80). After purchase or when grain is to be moved again, a conveying device (40) can move all or a portion of the grain into a grain truck (60) and this grain transfer is automatically recorded when the reader (20) at the start of the conveying device (40) comes into proximity of the tag (30) on the bottom of the grain storage bin and when the reader (20) at the end of the conveying device comes into proximity of a tag on the grain truck (60).

FIG. 2 shows another embodiment of the grain tracking system, specifically highlighting potential points where data is collected and transmitted to a virtual repository. In this embodiment, the harvester (10) moves grain via a conveying device (40) into a grain cart (50), and at this point a reader/tag system (90) records data regarding the grain transfer. This information can be immediately uploaded to the virtual repository (100) or temporarily stored until an adequate wireless signal can be established, at which point the data is uploaded to the virtual repository (100). The grain cart (50) is then pulled to a grain truck (60) where the grain is offloaded via a conveying device (40), and a reader/tag system (90) records data regarding the transfer. This data is then immediately or subsequently uploaded to the virtual repository (100). The grain truck (60) then travels to a grain storage site, where the grain is offloaded via a conveying device (40) and into a grain storage bin (80). In this embodiment, data is collected by a reader/tag system (90) and uploaded to the virtual repository (100) at the start of transfer of the grain from the grain truck (60) to the conveying device (40) and upon entry of the grain into the grain storage bin (80). At a user-defined time, the grain stored in the grain storage bin (80) can then be transferred into a grain truck (60) via a conveying device (40) for distribution. Data can also be recorded by a reader/tag system (90) and immediately or subsequently uploaded to the virtual repository (100) at this point.

It is also envisioned that between the transfer of an agricultural product from one container to another that the agricultural product may be placed on a scale to get a weight measurement. In some embodiments, a weight measurement may be automatically taken within the transport container by a load cell or a load cell array arranged within the container. Alternatively or additionally, the weight measurements may be automatically taken by one or more of a capacitive sensor, a hydraulic and pneumatic sensor, a strain gauge, a force sensitive sensor, or combinations thereof. The measured weight would then be transmitted by a wired or wireless communication technology and automatically transferred to the database in association with the appropriate identifier (dependent on the stage at which the weight measurement was taken). The date, time, equipment involved and location of the weight measurement may also be recorded and stored in the database. If desired, multiple weights may be taken and recorded at various points in the transportation system.

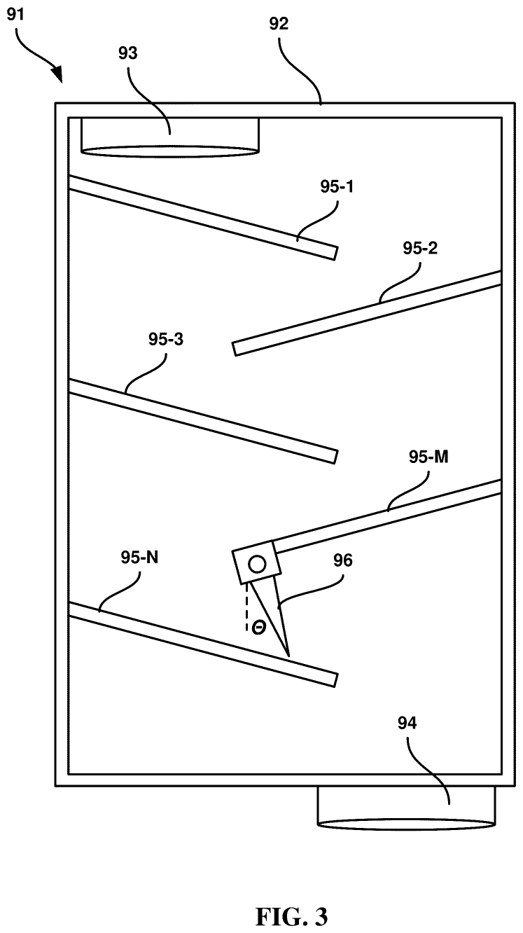

It is further envisioned that the volume of an agricultural product collected at a given stage may be measured and automatically uploaded to the database in association with a given identifier. The volume may be recorded, for example, by correlating the weight of the product with a predetermined product density which can be optionally determined at harvest time, by a series of level sensors arranged at specific fill percentage locations on the harvest, transport and storage equipment, by flow meters arranged at delivery ports between stages such as the example volumetric flow meter discussed further below with reference to FIG. 3, etc.

FIG. 3 shows a front plan cross-sectional view of an example volumetric flow measuring device (91) that can be used according to the present embodiment. The example volumetric flow measuring device (91) includes a vertical chute body (92) with an inlet (93) and an outlet (94) so that the agricultural product flows from the inlet (93) to the outlet (94) through the vertical chute body (92) by means of gravity. The volumetric flow measuring device (91) further includes a plurality of angled sidewall baffles 95-1 to 95-N (collectively referred to as the baffles (95) and individually referred to as a baffle (95)). Subsequent baffles (95), are arranged in different directions with respect to each other to change the direction of the agricultural product and thereby remove the momentum of the agricultural product flow as the agricultural product flows through the vertical chute body (92), so that the agricultural product flow achieves a steady-state flow, similar to a laminar flow, such that the cross-sectional area of agricultural product perpendicular to a direction of the flow achieves a steady state value, and so that the speed of the agricultural product achieves a constant value. A gate (96) is provided along the path of the agricultural product, for example, between baffles (95-M) and (95-N). The gate (96) is configured to change its angle of aperture O in response to the agricultural product flowing through the gate (96). By measuring the angle O the cross-sectional area of the agricultural product flow perpendicular to the direction of flow can be determined, and by measuring changes in the angle O through time, and based on, for example, a pre-determined (for example, by means of an initial calibration step) constant speed of the agricultural product flow through the vertical chute body (92), the volumetric flow of the agricultural product can be determined. In another embodiment, the device may optionally contain one or more flow speed sensor(s) devices in the cross-sectional area of the agricultural product flow to determine the exact speed of the product flow through the gate. The example volumetric flow measuring device (91) shown in FIG. 3 has a rectangular prism shape, however, other shapes, such as, for example, a cylindrical shape may be provided.

The weight and/or the volume measurements of the different batches of an agricultural product can be retrieved from the database for verification operations throughout the different stages of storage, transport and delivery of the agricultural product, for example, a cart scheduled to transport more than one batch of agricultural product at the same time can be expected to weight the sum of the recorded weights of the batches it is scheduled to transport and be filled up to a volume percentage corresponding to the sum of the recorded volumes of the batches it is scheduled to transport, so that, when the scheduled batches are loaded to the cart, their actual weight and volume can be verified against the recorded weights and volumes in the database.

Additionally, the volume measurements of the different batches of the agricultural product can be used in lieu of a CAD model of the batch in the virtual space, the batch in the virtual space comprising the stored sensor data associated to a physical batch of agricultural product, to mirror the physical batch of agricultural product as a digital twin would mirror the physical batch with a lower computational resource requirement than that of a digital twin. For example, the volume measurements of a batch can be used to plan and schedule transport and storage equipment to handle the volume in accordance to volume handling capacity of the equipment, such as, for example when a batch is stored in a plurality of sacks, the volume measurements of the batch can be used to know the number of sacks of a certain capacity that will be required to store the batch. Furthermore, if, for example, the shape of the sacks (or other storage equipment) is known, storage space within a storage facility can be scheduled to accommodate the sacks holding the batch of agricultural product based on the number of sacks and their shape.

In the grain tracking embodiment described above, it is also envisioned that solid particulate flow dynamic calculations and simulations may be used as grain flows from one container to another to predict, within a reasonable degree of certainty, where a given Batch, Processing Group or Transport Group of grain would be at any given time, and particularly within the storage bin to determine where a small portion of a batch was grown in a particular field (coordinate) location.

In a further embodiment, physical samples of the collected agricultural product may be taken at one or more points along the transportation and storage system. For example, physical grain samples may be taken before or during offloading into the grain storage bin. These samples may be put and sealed into tamper-proof containers and labelled with sensor data, identifiers (Batch, Processing Group and/or Storage Group) and/or any other data collected with respect to the quality or quantity available for said grain. The tamper-proof containers may be pails, bags, or jars, without being limiting. It is further envisioned that these samples may be manually collected or taken by an automated device. The number of samples taken by an automatic device may be varied depending on the needs of the farmer/harvester/distributer/purchaser. Further the size of the samples can be user defined, with a preferred size being approximately 1 kg. The samples collected may be serialized and stored separately from the respective storage bin, and these serialized samples can be recorded in the database to be associated with the given Storage Group. Samples can then be used for nutritional or other analyses, and for marketing to clients. With samples that are taken automatically, the system will ensure that all sampling, containerizing/bagging, sealing and marking will be done in an enclosed device that is tamper-proof, and will not operate in a way that samples can be manipulated, such that the sample is a trustworthy representation of the batch from which is was taken.

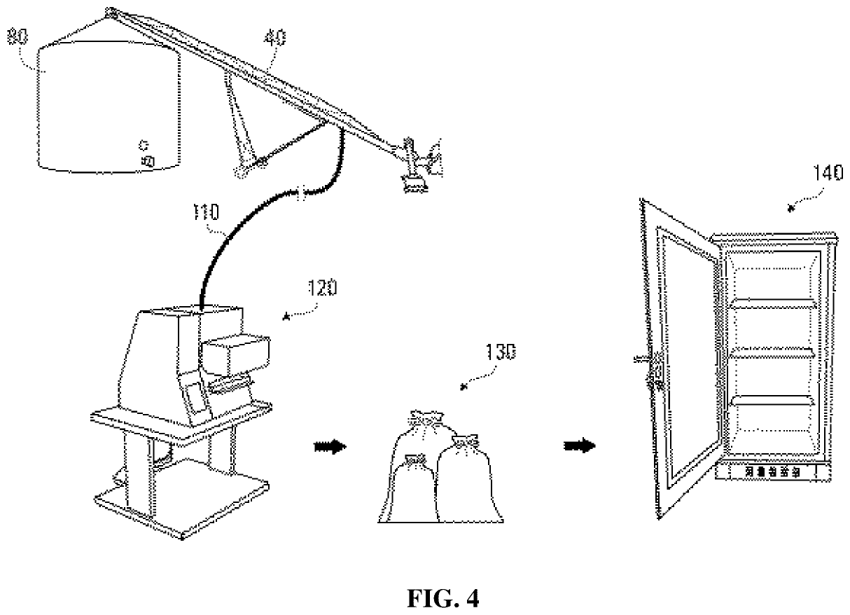

FIG. 4 shows a particular embodiment of a sampling system for grain. In this embodiment, a gaited tap (110) that is either permanently or reversibly attached to a grain auger allows a portion of grain to travel into an automated sampling machine (120) while the grain is being moved into storage. The automated sampling machine (120) may collect the desired volume of grain into tamper-proof containers (130), which will then be automatically labelled with some or all of the data collected for that particular Batch, Processing Group, and/or Transport Group of grain. The tamper-proof containers (130) may then be stored in a separate storage unit (140) and subsequently used for marketing or analyses.

It is contemplated that the labels on the tamper-proof containers (130) may simply link to the data associated with the packaged agricultural product via a unique identification number associated to the batch of agricultural product to which the sample corresponds, provided on the labels, by means of, for example, a, RFID chip, a bar code, a QR code, or serial number, without being limiting, such that the samples become representations of the batch in terms of grain attributes (such as quality, colour, protein content and other value or grade indications). A user interacting with the sample may use a web-browsing enabled device, such as, for example, a smartphone, a tablet, or a laptop, to read the unique identification number on the labels of the tamper-proof containers (13), for example, by scanning a QR code on the labels, to access the data of the batch that the sample represents.

In the example given above, the gaited tap that allows grain to flow into the automatic sampling machine is envisioned to be either automatically or manually controlled, and may allow for the precise control of grain volumes collected.

It is further envisioned that the agricultural product stored in the storage bins may be further tracked via sensors and tags when transported between storage bins or when transported from storage bins to the purchaser. Specifically, date, time, equipment involved and location data may be automatically transferred to the database in association with the Storage Group data when a tag in the storage bins comes into proximity to a reader or sensor present on the conveying device. The outlet of the conveying device may also have a sensor or reader that automatically transfers at least date, time, equipment involved and location data when it comes into proximity to a tag on a transport container. It is envisioned that the agricultural product would be tracked when it undergoes any movement, even movement that would be for cleaning or processing in some manner, without being limiting.

This agricultural product tracking system may also include the automatic monitoring of that product in storage. Specifically, measuring, monitoring or interpreting the agricultural product or environmental monitoring systems, for conditions such as moisture and temperature, without being limiting, at the storage site and continually updating this information in the database. These product lifecycle condition data would be associated with the batch information for traceability and quality purposes. Access to this type of information in the database could be valuable for farmer's who are marketing their agricultural product, and also to purchasers who have contracted the agricultural product and want to monitor its status while it is being held before transport.

Additional information may be manually input into the database, such as records of storage bin cleanouts, as well as previous crops held in a given storage bin, truck containers, carts, tanks, or any of the conveying devices.

It is further contemplated that food processors that utilize the agricultural product may manually input additional data into the database, such as the date the agricultural product was received, processing date, and final product produced from said agricultural product, so that the end retailer or consumer of said product can have access to the complete history of the agricultural product used.

This agricultural product tracking method and system may be beneficial to both the farmer and purchaser. The farmer benefits by having a more marketable product, being able to inform the consumer of the history, properties, quantity and location of the agricultural product being sold. The farmer further benefits from the fact that this information is gathered automatically, with no or limited user input. The purchaser also benefits by being able to buy with confidence, knowing the quality, quantity and history of the product being purchased.

With particular regard to grain as the agricultural product, this method and system will allow the farmer to know exactly what is on the farm and being sold, and will allow for accurate grain blending and the potential for coordination between different farms to blend grain at the delivery point. The farmer also benefits from being able to have the grain bought when it is in the storage bin, with the grade and dockage known prior to shipping. Relatedly, the purchaser benefits by being able to select for a grain product (or blends) with desired properties and knowing the quantity and quality of said grain before purchase. Furthermore, grain buyers will be able to better utilize grain storage, and accept just-in-time delivery at their facility given that they know what they are going to receive.

For instance, livestock producers that use grain as part of their feed may want a certain nutritional profile for their grain that is higher in protein, which may be more prominent in a given soil type, input parameters, or under certain growth conditions. Consulting the database that has compiled the information gathered along the grain tracking system would allow the farmer to better market its product to the client, and would allow the client to buy with confidence, knowing that they will get grain of certain quality and have access to a certain amount, with precise details of the grain history from field-to-market.

The types of grain that could be tracked by the described method and system include, but are not limited to, barley, rye, mustard, buckwheat, sorghum, wheat, peas, lentils, oats, corn, rice, soybeans, hay, cottonseed, millet, oilseeds, beans and quinoa.

It should be recognized that features and aspects of the various examples provided above can be combined into further examples that also fall within the scope of the present disclosure. In addition, the figures are not to scale and may have size and shape exaggerated for illustrative purposes.

The scope of the claims should not be limited by the embodiments set forth in the above examples but should be given the broadest interpretation consistent with the description as a whole.

1. A method of autonomously tracking a batch of agricultural product, comprising:
creating a batch of agricultural product at a point of harvest in a virtual space that mirrors and is associated with a physical batch of harvested agricultural product;
detecting, by a plurality of sensors, the presence of radio-frequency identification (RFID) tags respectively associated with different stages of agricultural product harvest, transportation, and storage, wherein each of the plurality of sensors are configured to identify the batch of agricultural product and to send sensor data in association with a batch identifier, wherein the sensor data are at least one of time of agricultural product movement, date of agricultural product movement, equipment involved and location;
sending to a virtual or physical database the sensor data collected by the plurality of sensors in association with the batch identifier;
storing in the virtual or physical database the sensor data received from the plurality of sensors in association with the batch identifier;
receiving a query for the batch of agricultural product;
response to the query, accessing the physical or virtual database to determine the associated sensor data for said batch of agricultural product; and
outputting the sensor data and associated batch identifier for display.

2. The method of claim 1, wherein additional data is input into the database or measured by additional sensors and associated with the batch of agricultural product, wherein the additional data is collected before agricultural product movement, during agricultural product movement, after agricultural product movement, or any combination thereof.

3. The method of claim 2, wherein the additional data of the batch of agricultural product comprises one or more of: volume, mass, harvest location coordinates, moisture content, protein content, crop variety, crop type, nutritional properties, seed application data, chemical application data, fertilizer application data, soil conditions, soil type, agronomy data, seed type, certifications, weather data throughout crop lifecycle, crop-specific data, carbon sequestration or emissions, or any combination thereof.

4. The method of claim 3, further comprising accessing the database to determine one or more properties associated with the batch of agricultural product in response to the query, and outputting the one or more properties of the batch of agricultural product.

5. The method of claim 1, wherein at least one of the plurality of sensors, the RFID tags and a Global Positioning System (GPS) locating device are placed on one or more of a harvester, tank, cart, truck, truck container, auger, leg, conveying device, and storage bin.

6. A system for autonomously tracking a batch of agricultural product, comprising:
a processor; and
a non-transitory computer-readable memory having computer-executable instructions stored thereon, which when executed by the processor configure the system to perform the method of claim 1.

7. The system of claim 6, further comprising the plurality of sensors.

8. The system of claim 6, further comprising:
a system and components for serialized sampling of a batch of agricultural product, wherein the samples are collected from a location along the different stages of agricultural product harvest, transportation, and storage, wherein the serialized samples are collected, segmented into tamper-proof containers, and stored separately from a storage bin for said batch and are virtually associated with the batch of agricultural product via a unique identification number, label, RFID chip, bar code, QR code, or serial number, wherein the agricultural product samples are representative samples of the batch from which they were taken.

9. The system of claim 8, wherein the tamper-proof containers are bags, jars, or pails.

10. The system of claim 9, wherein the tamper-proof containers are affixed with a label with the batch and sensor data, as defined in claim 1, and optionally some or all of the additional data as defined in claim 4.

11. A method for autonomously tracking a batch of an agricultural product, the method comprising:
creating a batch of agricultural product at a point of harvest in a virtual space that mirrors and is associated with a physical batch of harvested agricultural product;
detecting, by a plurality of sensors, the location and working state of harvesting, transportation and storage equipment handling the agricultural product wherein each of the plurality of sensors are configured to collect and send sensor data, wherein the sensor data includes at least one of time of agricultural product movement, date of agricultural product movement, equipment involved, operational state of the equipment involved and location;
sending to a processor the sensor data collected by the plurality of sensors;
determining, by the processor, a state of the batch of agricultural product based on the sensor data and associating a batch identifier with the sensor data;
sending to a physical or virtual database the sensor data in association with the batch identifier;
storing in the virtual or physical database the sensor data in association with the batch identifier;
receiving a query for the batch of agricultural product;
in response to the query, accessing the physical or virtual database to determine the associated sensor data for said batch of agricultural product; and
outputting the sensor data and associated batch identifier for display.

12. The method of claim 11 wherein the plurality of sensors are further configured to detect at least one of an orientation, a speed, an acceleration and a relative position with respect to other equipment of the harvesting, transportation and storage equipment.

13. The method of claim 11 wherein the plurality of sensors are further configured to detect at least one of a change in weight and a direction of change in weight and sub-equipment working state of the harvesting, transportation and storage equipment.
